(19) United States
(12) Patent Application Publication
(10) Pub. No.: US 2016/0100651 A1
(43) Pub. Date: Apr. 14, 2016

(54) Manually Operated Electrical Power Generators For Body Heating and Powering Other Devices

(71) Applicants: Jahangir S. Rastegar, Stony Brook, NY (US); Thomas Spinelli, Northport, NY (US)

(72) Inventors: Jahangir S. Rastegar, Stony Brook, NY (US); Thomas Spinelli, Northport, NY (US)

(73) Assignee: OMNITEK PARTNERS LLC, Ronkonkoma, NY (US)

(21) Appl. No.: 14/512,444

(22) Filed: Oct. 12, 2014

(51) Int. Cl. A43B 7/04; H02K 11/00; H02K 7/10; H02K 5/22; H02K 7/02

(52) U.S. Cl. CPC A43B 7/04; H02K 5/225; H02K 7/02; H02K 7/10; H02K 11/0094

(57) ABSTRACT

A portable electrical generator including: a housing; a generator disposed within the housing and operable by a user from outside the housing to generate electrical energy; an output for outputting the energy from the generator to another device; and a connector to connect the housing to an other device or an article of clothing. The generator can include a cord having a portion within the housing and a portion movable outside the housing and connected to the generator such that pulling the cord to move the movable portion away from the housing produces the energy. The output and the connector can include contacts disposed on an external surface of the housing where the contacts can be magnetic contacts for releasably connecting the housing to mating magnetic contacts on the other device or the article of clothing.

### BACKGROUND OF THE INVENTION

1. Field of the Invention

The present invention relates generally to manually operated electrical power generators for heating human body and powering other devices, and more particularly to manually operated electrical power generators for heating body extremities such as toes and fingers to protect them from frost bite and for powering devices used in emergency situations such as for broadcasting location and need.

2. Prior Art

During many outdoor activities in the winter time or in a cold environment, such as during mountain climbing, hiking, skiing, or performing varieties of tasks such as outdoor repairs, clean-up operations and the like, the body. and particularly its extremities, such as feet inside shoes and boots or hands inside gloves, can get very cold, and can lead to frostbite, particularly at the toes. At the very least, such conditions can be very uncomfortable for the person exposed to the cold environment. A solution has been to provide certain means to warm the feet, particularly the toes. An appropriate amount of insulation has also been provided to minimize the amount of the heat that is needed to keep the entire feet more uniformly warm.

The provision of proper and highly effective insulation to keep heat inside and moisture outside the clothing, gloves and shoes and minimize heat loss is very well known in the art and is being widely practiced.

The provision of heating elements to generate heat inside the shoes has also been disclosed, for example, in the following patents.

U.S. Pat. No. 4,674,199 discloses a shoe with an internal warming mechanism which comprises an electrical resistance coil in the sole or upper coverings of the shoe, and with an electrical generation mechanism in the heel of the shoe which is driven by the up-and-down movements of the heel. The electrical generator includes an armature mounted for rotational movement in a magnetic field and mechanically connected to a vertical post which is dependent on the undersurface of the heel portion of the inner sole of the shoe. The post is connected through a vertical spiral groove to a sleeve which is coupled with an escapement to a flywheel that is unidirectionally driven by the sleeve. The flywheel is coupled through a gear train to the armature of the electrical generator.

There are several shortcomings with such devices. Firstly, the wearer can generate heat only while walking and the heat generation stops after walking stops. Thus, if the user were to be stationary, such as sitting in the stands of a football game, the device would not operate to generate heat. Secondly, the amount of energy that can be generated during each step is very limited and on the order of milli-Joules and not enough to keep the wearer war at relatively low temperatures. For example, a person with a mass of 80 Kg (180 lb), in order to generate 400 Joules of energy, which is approximately needed to increase the temperature of the toes (considered to be equivalent to 100 gram of water in heat capacity) by one degree C. (assuming no losses), will require the person to take a achieve about 0.5 meter of vertical drop (weight times the drop height), which is obviously too tiring and impractical and is similar to climbing 0.5 meter stairs. This means that a tired and cold user, with very cold toes, has to engage a rigorous walking/running exercise to warm up his toes just a few degrees.

The third shortcoming of such devices is that the mechanism for transforming up and down motion to rotary motion of the indicated flywheel is highly inefficient and requires significantly more work from the user than the aforementioned calculations indicate.

U.S. Pat. No. 5,722,185 is directed to a heated shoe having a heel, a sole provided with a heating device and an outside face for making contact with the ground, and at least one energy-providing battery located in the heel and connected to the heating device. In this patent, the heating device comprises a heating film or cloth extending over at least a portion of the sole parallel to its outside face. The sole also includes a structure of closed cells extending between the heating film or cloth and the outside face of the sole. The shortcoming of the disclosed device is the need for a battery, which can only provide energy for heating of the toes for a relatively short time, e.g., about one hour for a reasonably sized battery.

U.S. Pat. No. 6,041,518 discloses a battery powered climate-controlled shoe which controls the climate surrounding a user's foot in the shoe during a wide range of weather conditions. The shoe contains a plurality of switches, one of which is an interlock for inhibiting operating of the system until a pressure sensitive switch is activated by the insertion of a foot into the shoe. The shoe also contains a fan and a metallic heating plate. The fan aids in the circulation of air within the shoe, and the heating plate provides warm air for circulation within the shoe during cold weather.

The devices disclosed in the above two patents are therefore not suitable for those who would engage even a 3-4 hour hike or other similar activity without carrying a heavy load of batteries.

U.S. Pat. No. 6,041,518 discloses a frictional heat generator and a forced air circulation system for shoes and boots such as ski boots. The shoe has an inner sole which is formed of a pair of sole plates which are mounted for relative sliding movement in the shoe. The upper sole plate is pivotally attached at its toe end to an outer sole of the shoe. The lower sole plate of this pair is pivotally mounted with a crank arm which is located at its heel end. Twisted torsion cables are provided to bias the sole plates upwardly against the applied weight of the wearer. A compartment is formed in the shoe between the pair of sole plates and outer sole and is enclosed with a diaphragm to function as a bellows-type air pump to circulate air through the shoe.

U.S. Pat. No. 8,087,186 discloses a piezoelectric-based generator that uses vibrating mass-spring units to generate electrical energy to heat toes. The mass-spring is excited by the wearer impacting the shoe against an object, following which the mass-spring units are excited and begin to vibrate. The mass-spring units would then exert a cyclic load on the piezoelectric elements, thereby generating electrical energy which is then used to heat the toes via resistive heating elements.

The inclusion of electrical energy generators in the heels that rely on the pressure exerted by the body during walking and the like makes the user spend a lot of energy during normal walking since the heel has to deform, bringing the body downward, i.e., the entire body weight has to move down a certain distance to provide mechanical energy equal to the weight of the person times the distance that the body has displaced down. This is equivalent to the person moving up steps of equal amount or walking on sand and would be very tiring to the user. Such electrical energy generation devices are also very inefficient, thereby providing a very small portion of the energy spent by the wearer to useful electrical energy for heating the feet, thereby making them impractical. In addition, such devices developed to date do not provide enough energy to warm the feet and toes enough to avoid frostbite and other maladies, particularly in very cold environments.

The second option in the prior art uses batteries to power heating elements. Batteries of various types, however, provide a very limited amount of electrical energy. Batteries, particularly rechargeable batteries, are adequate for applications in which the user is in the cold environment for relatively short periods of times. However, for applications such as hiking, mountain climbing or even for those working outdoors for several hours at a time, batteries do not provide an adequate amount of electrical energy.

A need therefore exists for methods and devices to provide the means to warm up body parts, such as feet inside boots worn in very cold areas subjecting the body, particularly the extremities such as feet, particularly the toes, to frostbite and other related complications or merely to provide a more comfortable situation for those exposed to cold environments for prolonged periods. Such devices should be capable of providing significant amounts of heat to the interior of shoes, gloves and the like that are required to keep the feet and hands, particularly the toes, warm enough to avoid various maladies or uncomfortableness. Such devices can be used in almost any footwear, for example, construction boots, hiking boots, climbing boots, arctic shoes, ski boots, gloves, and the like.

In addition, electrical energy generated and used to generate the source of heating the feet and hands and the like may also be used part or in entirety for powering electrical and electronic devices or other electrical elements such as lighting means directly or via certain electrical energy storage device. The electrical energy may also be used to charge electrical energy storage devices such as rechargeable batteries and capacitors for later use.

### SUMMARY OF THE INVENTION

Accordingly, a method and related devices for manual generation of electrical energy that can be used to heat a body portion, for example, by incorporating it into the shoes, socks or other articles of clothing (alternatively referred to as apparel) to heat the toe regions of the foot, and/or providing electrical energy for powering other electrical and electronic devices and the like are provided.

Hereinafter, the method and the basic device for heating part of the body are described by their application to a footwear into which such a device is integrated for the purpose of heating the foot in general and the toe region of the foot in particular to keep it warm and prevent frost bite, with the option of providing the shoe/boot with an outlet for powering electrical, electronics and other similar devices. Also, hereinafter all types of footwear are collectively referred as shoes. Furthermore, the devices disclosed herein are equally applicable to any article of clothing (footwear being considered herein as an article of clothing), such as socks, gloves, hats and other articles.

Accordingly, a portable electrical generator is provided. The portable electrical generator comprising: a housing; a generator disposed within the housing and operable by a user from outside the housing to generate electrical energy; an output for outputting the electrical energy from the generator to another device; and a connector to connect the housing to one or more of an other device or an article of clothing.

The generator can include a pull cord having a portion within the housing and a portion movable outside the housing and connected to the generator such that pulling the pull cord to move the movable portion away from the housing produces the electrical energy. The pull cord can further comprise a pull means at the portion movable outside the housing for facilitating grasping of the pull cord by a user.

The output and the connector can comprise one or more contacts disposed on an external surface of the housing. In which case, the one or more contacts can be magnetic contacts for releasably connecting the housing to mating magnetic contacts on the one or more of the other device or the article of clothing.

The can be an electric connector or an energy storage device.

The connector can be a mechanical connection to fix the housing to a surface of the one or more of the other device or the article of clothing.

The connector can be a cord connecting the output to an input of the one or more of the other device or the article of clothing.

The portable electrical generator can further comprise a flywheel directly connected to a drum around which the pull cord is wound.

The portable electrical generator can further comprise gearing provided between the drum and the flywheel for increasing a rotation speed of the flywheel as compared to the drum. The portable electrical generator can further comprise a power spring connected driving one of the flywheel or generator. The portable electrical generator can further comprise gearing provided between the drum and the power spring for increasing a rotation speed of the power spring as compared to the drum.

The portable electrical generator can further comprise a clutch for allowing the pull cord to be pulled multiple times to increase the electrical energy output each time the pull cord is pulled.

Also provided is a device comprising: a body; an internal energy consuming component; and a generator attached to the body such that an output of the generator provides electrical energy from the generator to the internal energy consuming component.

The body can be an article of clothing such as footwear.

The body can be an electrical/electronic device.

The internal energy consuming component can be a heater.

The device can further comprise an electrical connector disposed on a surface of the body and electrically connected to the internal energy consuming component, the electrical connector transferring the electrical energy output from the generator to the internal energy consuming component.

The device can further comprises a first set of contacts connected to the output of the generator and a second set of contacts electrically connected to the internal energy consuming component, wherein the first and second sets of contacts are electrically connected to each other.

The first and second sets of contacts can be magnetic contacts for releasably connecting the generator to the body.

The body can include first and second bodies, wherein the second body includes the internal energy consuming component and the second body further comprises a third set of contacts for electrically connecting the first and second sets of contacts.

The first, second and third sets of contacts can be magnetic contacts for releasably and electrically connecting the generator to the first body and the first body to the second body. The third sets of contacts can comprise wiring electrically connecting the first and second sets of contacts.

Still further provided is an electrical/electronic device comprising: a housing; an internal energy consuming component disposed within the housing; and a generator disposed with the housing body such that an output of the generator provides electrical energy from the generator to the internal energy consuming component; wherein the generator includes a pull cord having a portion within the housing and a portion movable outside the housing and connected to the generator such that pulling the pull cord to move the movable portion away from the housing produces the electrical energy.

### BRIEF DESCRIPTION OF THE DRAWINGS

These and other features, aspects, and advantages of the apparatus of the present invention will become better understood with regard to the following description, appended claims, and accompanying drawings where:

FIG. 1 illustrates a first embodiment of a footwear having electrical energy generators for producing energy to heat a portion of a wearer's foot.

FIG. 2 illustrates the first embodiment of a pulling cord operated electrical energy generator for use in the footwear of FIG. 1.

FIG. 3 illustrates the schematic of the interior of the cord wheel of the generator of FIG. 1 and its cord retracting torsion spring.

FIG. 4 illustrates a second embodiment of a pulling cord operated electrical energy generator for use in the footwear of FIG. 1.

FIG. 5 illustrates a third embodiment of a pulling cord operated electrical energy generator for use in the footwear of FIG. 1.

FIG. 6 illustrates a standalone embodiment of a pulling cord operated electrical energy generator.

FIG. 7 illustrates a standalone embodiment of a pulling cord operated electrical energy generator adapted to be worn on the user wrist.

FIG. 8 illustrates a variation of the pulling cord operated electrical energy generator removably provided on an article of clothing.

FIG. 9 illustrates a variation of the pulling cord operated electrical energy generator removably provided on an article of clothing and being electrically connected to another article of clothing through electrical contacts.

FIG. 10 illustrates a variation of the pulling cord operated electrical energy generator at a first location on a first article of clothing and being electrically connected to another article of clothing through electrical contacts at a second location on the first article of clothing.

FIG. 11 illustrates a variation of the pulling cord operated electrical energy generator on one article of clothing and being electrically connected to another article of clothing through electrical contacts.

FIGS. 12a and 12b, illustrate generators for use with electrical/electronic devices configured as a flashlight, where FIG. 12a includes a releasably connected generator and FIG. 12b includes an integrally formed generator.

FIGS. 13a and 13b, illustrate generators for use with electrical/electronic devices configured as a smartphone, where FIG. 13a includes a releasably connected generator and FIG. 13b includes an integrally formed generator.

### DETAILED DESCRIPTION OF THE PREFERRED EMBODIMENT

Although the present invention is applicable to heating of the human body and in particular extremities such as toes and fingers, and/or for providing electrical energy to power numerous types of electrical and electronics devices, it is particularly useful for heating toes and hands/fingers to protect them against frost bite and for powering emergency electronics equipment such as emergency transmitters, cell phones, radios, lighting, and fire starting equipment and the like. Therefore, without limiting the applicability of the present invention to human footwear for heating toes, it will be described for such an application. Similarly, for electrical devices and without limiting the applicability of the present invention to lighting devices, it will be described for such an application. Furthermore, for the purpose of continuously powering electrical and electronics and other similar devices, the generated electrical energy is generally stored in certain intermediate electrical energy storage devices such as rechargeable batteries and/or capacitors.

Although this invention is applicable to numerous and various types of footwear, it has been found particularly useful in the environment of boots. Therefore, without limiting the applicability of the invention to boots, the invention will be described in such environment. Those skilled in the art will appreciate that the invention can be used on other types of footwear, such as shoes, sneakers, socks and different types of boots, such as hiking and ski boots.

Furthermore, although this invention is applicable to numerous and various uses for the electrical energy produced by the footwear, it has been found particularly useful in the environment of converting the electrical energy to heat energy to warm the toes inside the footwear. Therefore, without limiting the applicability of the invention to converting the electrical energy to heat energy to warm the toes inside the footwear, the invention will be described in such environment. Those skilled in the art will appreciate that the invention can be used to convert the produced electrical energy to other types of energy or for other purposes, such as energy storage for powering portable electrical devices, heating other parts of the body or for cooling the foot or other parts of the body.

The disclosed footwear are based on one or more electrical energy generators that can be built into or otherwise directly attached to the footwear such as on the back or right side of the right boot and left side of the left boot to make them easily accessible by the wearer and prevent interference with the wearer activities. Then when the user pulls a generator cord, which causes a cord wheel over which the cord is wrapped to rotate, thereby directly or via a power spring winding mechanism would transfer the user input mechanical energy to a flywheel and permanent magnet generator to generate electrical energy. Other elements such as a one-way clutch can be provided to stop back driving and gearing may be used to achieve efficient electrical energy generation. The cord wheel can be provided with a return spring to wind the cord back over the cord wheel after each user pulling. The user can then pull the cord as many times as desired to generate the desired level of electrical energy and/or achieve the desired warming level of the toes or other intended parts of the body.

The generated electrical energy can then be used to generate heat inside the footwear using a heating device, which can be positioned around the toe area of the footwear. Heating devices (pads) that generate heat from electrical energy are well known in the art.

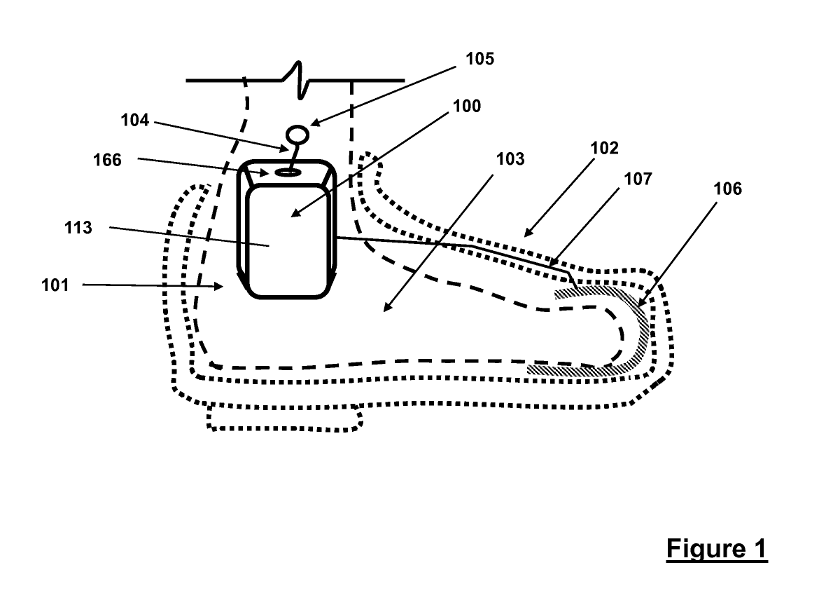

A schematic of one embodiment of an electrical generator is shown schematically in FIG. 1. In FIG. 1, at least one electrical energy generator 100 is embedded in the side wall 101 or attached to the side wall 101 of a footwear 102, in this case a boot, with the wearer foot 103 shown inside the footwear 102. The connection between the generator 100 and the sidewall 101 of the boot 102 can be fixed or releasable. Such releasable connections are well known in the art, such as magnetic, snaps, interference fittings, Velcro etc. while such fixed connections are also well known in the art, such as adhesive, sewn, screws, rivets and other fasteners. In general, when fixed, only a housing of the generator can be fixed, where the housing permits entry into an interior so as to service/replace components therein.

As a result of the wearer pulling the cord 104 (for example via an attached ring 105), the generator 100, described below in more detail, begins to generate electrical energy. The electrical energy can be provided directly through embedded wiring in the wall and/or sole of the footwear 102 (shown schematically at line 107) to the heating pad(s) 106. The heating pad(s) 106 would then provide heat to the foot 103, such as at least to the areas occupied by the toes. In the schematic of FIG. 1, heating pads 106 are shown only around the toes since they are usually injured first as a result of frostbite and need most protection. However, heating pads may also be provided around other areas of the foot or around the entire surface of the footwear 102 interior.

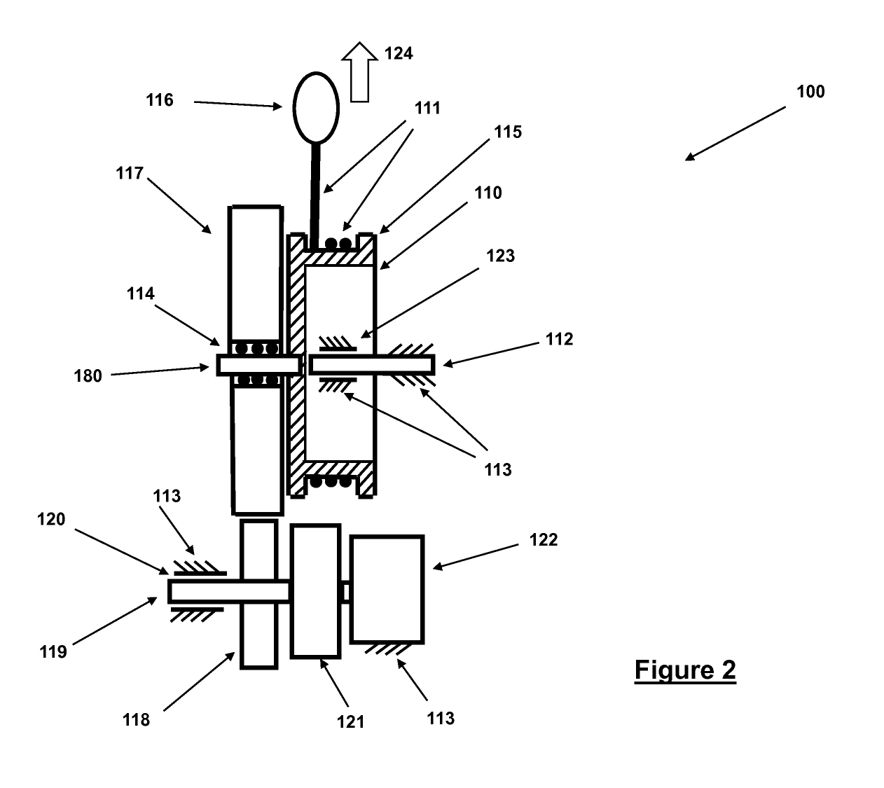

In one embodiment, the electrical energy generator 100 is constructed as shown schematically in FIG. 2. In FIG. 2, the side view of the internal components of the generator 100 are shown schematically without the generator housing 113 for the sake of clarity. The generator 100 includes a cord wheel 110, over which the cord 111 is wound. The cord wheel 110 is mounted on a shaft 112 with a bearing 123, over which it is free to rotate in either direction. The shaft 112 is fixed to the housing 113 (shown schematically in FIG. 2) of the generator 100 as shown in FIG. 2. A shaft 180 is fixed to the cord wheel 110 as shown in FIG. 2 over which is mounted a gear 117 via a one-way clutch 114. The housing 113 of the generator 100 is in turn attached to the footwear 102 as shown in FIG. 1. As described later, the housing can be permanently fixed to the footwear 102 or releasably connected to the footwear such that the same generator can be used for each footwear and/or for other articles of clothing. The cord wheel 110 can be provided with flanges 115 for cord 111 guidance as it winds over the wheel as described later. The cord 111 can be provided with means, such as a ring 116 to facilitate the user grabbing and forcefully pulling on the cord 111. An end of the cord 111 opposite the ring 116 can be fixed to the cord wheel 110.

The gear 117 is used to engage a pinion 118, i.e., a gear with a smaller number of teeth than the gear 117. As a result, the rotational speed of the pinion 113 relative to the rotational speed of the gear 117 would be higher by the ratio of the number of teeth on the gear 117 to that of the pinion 118. The gear 118 is in turn fixed to a shaft 119, which is free to rotate in the bearing 120 in the housing 113 of the generator 100. On the shaft 119 is also mounted a flywheel 121 and via the flywheel 121 to the rotor of a permanent magnet type electrical generator 122. The stator of the permanent magnet electrical generator 122 can be fixedly attached to the housing 113 of the generator unit 110.

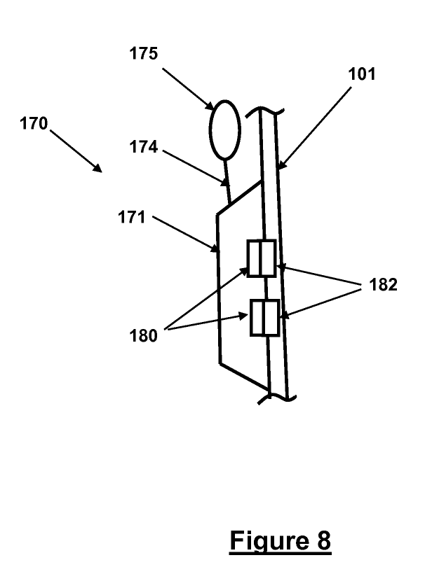

When the user rapidly and forcefully pulls the cord 111 in the direction of the arrow 124, the unwinding of the cord 111 forces the cord wheel 110 to begin to rotate, thereby causing the gear 117 to begin to rotate the pinion 118, thereby rotating the shaft 119 and therefore the flywheel and the input shaft of the permanent magnet generator 122. The permanent magnet generator 112 would thereby begin to generate electrical energy. It is noted that the one-way clutch 114 is mounted in the direction that would transmit torque as the cord wheel 110 is rotated during the unwinding of the cord 111 by the user pulling, but when the cord wheel 110 has stopped being rotated by the cord 111, the gear 117 is free to continue rotating freely about the shaft 180. The permanent magnet generator 122 is electrically connected to the heating pads 106 (or other electrical/electronic component) via wiring 107. However, as discussed below with regard to FIG. 8, the electrical connection between the permanent magnet generator 122 and the heating pads 106 (or other electrical/electronic component) can be via electrical contacts disposed on one an article of clothing, such as on the footwear 102 and can also be between sets of electrical contacts on more than one article of clothing, such as on the footwear 102 and a sock worn by the user 103.

It will be appreciated by those skilled in the art that if the user pulls the cord 111 in the direction of the arrow 124 by a force F (considered to be constant for the sake of simplicity) a distance L, then the work done by the user becomes

W=F L

Assuming no losses such as due to friction and neglecting the inertia of the cord 111, cord wheel and the shaft 180, then the work W done by the user is transferred to the rotating gears 117 and 118, the flywheel 121 and the rotating part of the permanent magnet generator 122 as kinetic energy, while a portion of it being converted to electrical energy by the permanent magnet generator 122. Then the stored kinetic energy is continuously converted to electrical energy by the permanent magnet generator 122 until the stored kinetic energy is exhausted and the gears 117 and 118, the flywheel 121 and the rotating part of the permanent magnet generator 122 come to a stop.

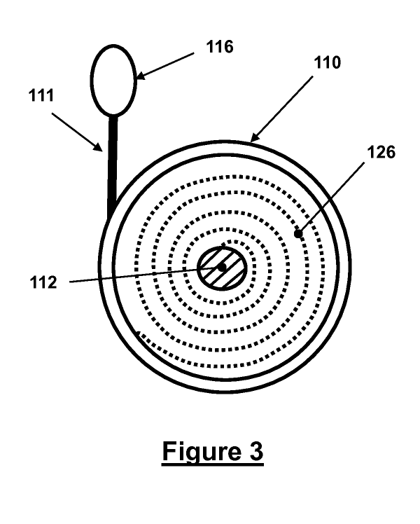

Once the user has partially or fully pulled the cord 111, the user can then release or slowly let the cord 111 rewind back over the cord wheel 110 by a provided torsion spring 126 shown in the schematic of FIG. 3, which biases the cord 111 to wind onto the cord wheel 110. The torsion spring 126 is fixed to the interior surface of the cord wheel 110 (not shown in the schematic of FIG. 2 for the sake of simplicity) on one end and to the shaft 112 (or alternatively directly to the housing 113 of the generator 100) on the other end. The torsion spring 126 is also preloaded such that when the cord 111 is fully retracted and wound over the cord wheel 110, there is still a minimal amount of residual torsional preloading left in the torsion spring 126 to keep the cord securely inside the generator 100 housing.

It will be appreciated by those skilled in the art that the user may operate the generator 100 by pulling the cord 111 multiple times, each time transferring more mechanical energy to the aforementioned rotating gears 117 and 118, the flywheel 121 and the rotating part of the permanent magnet generator 122 to generate more electrical energy. This is made possible by the provision of the one-way clutch 114, which would allow transfer of torque from the cord wheel 110 to the gear 177 through the shaft 180 but also allows free rotation of the gear 177 as the speed of rotation of the cord wheel 110 falls below that of the gear 177.

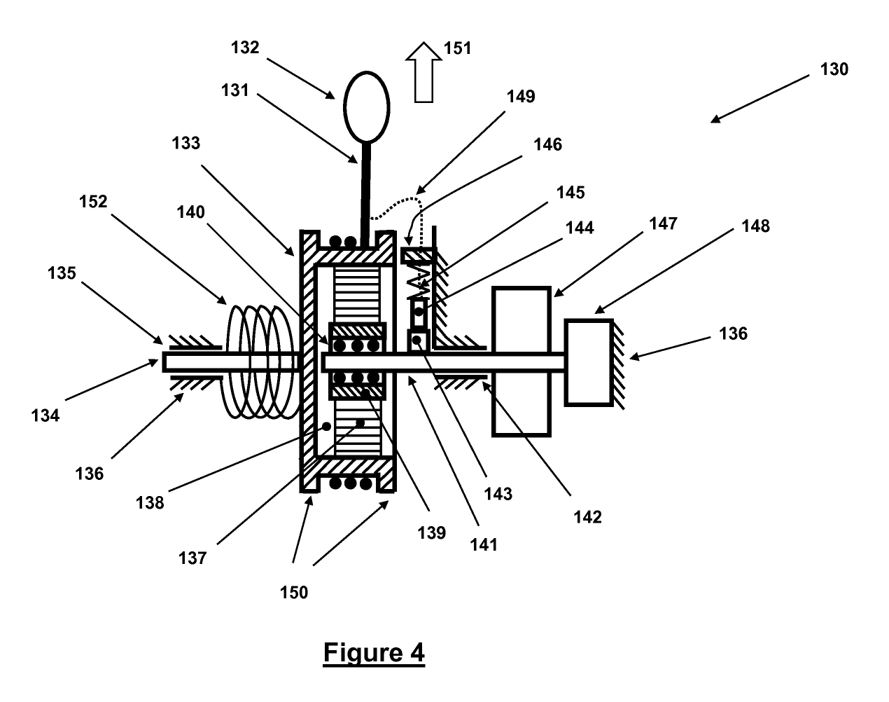

It will be appreciated by those skilled in the art that in a second embodiment, the pair of gears 117 and 118 may be eliminated and the shaft 112 may be directly connected to the flywheel 121 and permanent magnet generator shaft 119. The one-way clutch 114 is then used for mounting the cord wheel 110 over the shaft 112 and the cord wheel 110 is provided with a preloaded torsion spring similar to the torsion spring 152 shown in the schematic of FIG. 4, which is attached on one end to the housing 113 of the electrical generator housing 100 (136 in the embodiment of FIG. 4) and to the cord wheel 110 on the other end. As a result, after each pulling of the cord 111 by the user, the cord wheel 110 is biased to return to its pre-pull position, thereby forcing the cord 111 to be wound back over cord wheel 110. The user can then repeatedly pull the cord 111 and let it wind back over the cord drum 110, thereby generating the desired amount of electrical energy.

Such schematic of the second embodiment of the electrical energy generator 130 for use in the footwear 102, FIG. 1, is shown schematically in FIG. 4. One or more electrical energy generators 130 may be similarly used in place of the electrical energy generator 100 or in combination with one or more electrical energy generator 100 in a footwear as shown in the schematic of FIG. 1 or other wearable component for heating certain parts of the user body, for the case of a footwear for mostly heating the toe region, and for powering or charging electrical and/or electronic devices and other electrical energy consuming products. Then in a manner similar to that of the electrical energy generator 100, as a result of the wearer pulling the cord 131 (for example via an attached ring 132), the generator 130, as described below in more detail, begins to generate electrical energy. The electrical energy can be provided directly through embedded wiring to the heating pad(s) 106. The heating pad(s) 106 would then provide heat to the foot 103, such as at least to the areas occupied by the toes.

In the second embodiment, the electrical energy generator 130 is constructed as shown schematically in FIG. 4. In FIG. 4, the side view of the internal components of the generator 130 are shown schematically with the generator housing 136 shown schematically for clarity. The generator 130 consists of a cord wheel 133, over which the cord 131 is wound. The cord wheel 133 is fixed to the shaft 134, which can turn freely in the bearing 135, mounted in the housing 136 of the generator 130. In the provided space 138 inside the cord wheel 133 a power spring 137 is mounted with its outer end being fixed to the inside of the cord wheel 133 cavity 138 and its inner end being fixed to the outer surface of the sleeve 139. The sleeve 139 is mounted over the shaft 141 via a one-way cutch 140. The shaft 141 is free to rotate in the bearing 142, mounted in the housing 136 of the generator 130. On the shaft 141 is mounted a flywheel 147 and through the flywheel to the rotor of a permanent magnet type electrical generator 148. The stator of the permanent magnet electrical generator 148 is fixedly attached to the housing 136 of the generator unit 130.

The shaft 141 is provided with a rotational stop member 143 which would rest against a stop element 144. The stop element 144 can slide up or down in a guide (not shown) provided in the housing 136 of the generator unit 130. The stop element 144 is biased into the position against the rotational stop element 143 via the compressive spring 145, which is positioned between the stop element 144 and a support element 146 fixed to the housing 136 of the generator unit 130. The stop element 144 is provided to prevent rotation of the shaft 141 while the cord 131 is wrapped over the cord wheel 133 as shown in FIG. 4.

The cord wheel 133 can be provided with flanges 150 for cord 131 guidance as it winds over the cord wheel 133 as described later. The cord 131 can be provided with means such as a ring 132 to facilitate the user grabbing and forcefully pulling on the said cord. The opposite end of the cord 131 can be fixed to the cord wheel 133.

When the user pulls the cord 131 in the direction of the arrow 151, the unwinding of the cord 131 forces the cord wheel 133 to begin to rotate. The rotation of the cord wheel 133 results in the winding of the power spring 137. The winding of the power spring 137 tends to force the sleeve 139 to rotate, but the one-way clutch is oriented to transmit torque from the sleeve 139 to the shaft 141, and the stop element 144 prevents the shaft 141 from rotating since it is positioned against the rotational stop element 143. As a result, continuous pulling of the cord 131 in the direction of the arrow 151 and the resulting rotation of the cord wheel 133 results in continuous winding of the power spring 137. As a result, mechanical potential energy is increasingly stored in the power spring 137.

As the user continues to pull on the cord 131, at some point the cord 149, which is attached to the cord 131 on one end and to the stop element 144 on the other end, is tightened and further pulling of the cord 131 would slide the stop element up and away from engagement with the rotational stop element 143 of the shaft 141. As a result, the shaft 141 is now free to be rotated by the preloaded power spring 137. The preloaded power spring 137 will then begin to transfer its stored mechanical potential energy to the flywheel 147, shaft 141 and the rotor of the permanent magnet generator 148 as kinetic energy while a portion of the said mechanical kinetic energy is being transformed to electrical energy by the permanent magnet generator 148. Once the mechanical potential energy stored in the power spring 137 is transferred to the assembly of the shaft 141, flywheel 147 and the rotor of the permanent magnet generator 148, said assembly will continue to rotate and the one-way clutch 140 will prevent the assembly to back drive the power spring 137. The assembly of the shaft 141, flywheel 147 and the rotor of the permanent magnet generator 148 will then rotate until its stored kinetic energy is converted mostly to electrical energy and some to heat due to friction between the moving parts and losses in the permanent magnet generator 148. At this time, the user will let the cord 131 to be wound back over the cord wheel 133 by the preloaded biasing torsion spring 152. The torsion spring 152 is attached to the housing 136 of the generator unit 130 on one end and to the shaft 134 on the other end. The torsion spring 152 is provided with enough torsional preload to rotate the cord wheel 133 until the cord 131 is fully wound over the cord wheel 133 as shown in FIG. 4. The cord 131 can be provided with a stop element, such as the ring 132, to prevent the preloaded torsion spring 152 to pull the cord 133 inside the housing of the generator 130 through the passage 166 as shown in FIG. 1.

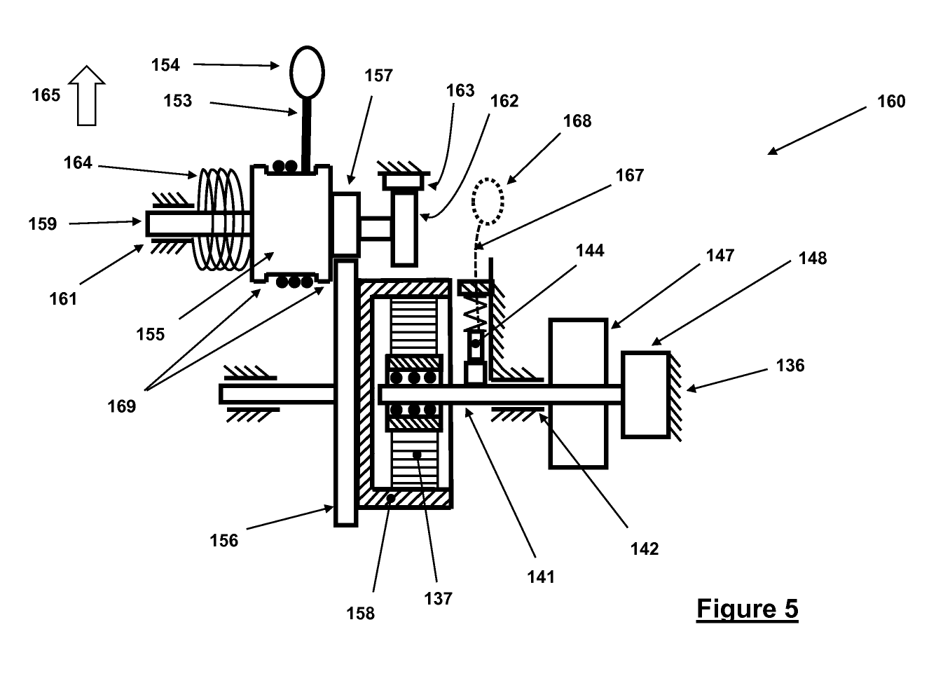

A schematic of the third embodiment of the electrical energy generator 160 for use in the footwear 102 is shown schematically in FIG. 5. One or more electrical energy generators 160 may be similarly used in place of the electrical energy generator 100 (FIG. 2) or 130 (FIG. 4) or a combination of two or all three electrical energy generators a footwear, as shown in the schematic of FIG. 1 or other wearable component for heating certain part of the user body, for the case of a footwear for mostly heating the toe region, and for powering or charging electrical and/or electronic devices and other electrical energy consuming products. Then in a manner similar to that of the electrical energy generator 100, as a result of the wearer pulling the cord 153 (for example via an attached ring 154), the generator 160, as described below in more detail, begins to generate electrical energy. The electrical energy can be provided directly through embedded wiring 107 to the heating pad(s) 106 (see FIG. 1). The heating pad(s) 106 would then provide heat to the foot 103, such as at least to the areas occupied by the toes. In the schematic of FIG. 1, heating pads are shown only around the toes since they are usually injured first as a result of frostbite and need most protection. However, heating pads may also be provided around other areas/all areas of the foot.

In the embodiment of FIG. 5, the electrical energy generator 160 is constructed similar to the embodiment 130 of FIG. 4, with the difference being that instead of the cord 131 being used to directly wind the power spring 137 via the cord wheel 133, the cord 153 (131 in embodiment of FIG. 4) is used to drive the cord drum 155, which would in turn wind the power spring 137 (mounted inside the drum 158—drum cord 133 in the embodiment of FIG. 4) via a pair of reduction gears 156 and 157 as described below. All other components of the embodiment 160 (power spring 137 to the permanent magnet generator 148, including the previously described shaft 141 stop elements) are identical to those of the embodiment 130 of FIG. 4.

In FIG. 5, the side view of the internal components of the generator 160 are shown schematically with the generator housing shown schematically at 136. The power spring 137 winding mechanism of the generator 160 consists of the cord drum 155, over which the cord 153 is wound. The cord drum 155 mounted on the shaft 159 via a one-way clutch (not shown) similar to the one-way clutch 140 between the sleeve 139 and the shaft 141. The shaft 159 can turn freely in the bearing 161, mounted in the housing 136 of the generator 160. The gear (pinion) 157 is also fixedly mounted on the shaft 159 and engages the gear 156, which is fixed to the drum 158 and the shaft 156 as shown in FIG. 5. A ratchet wheel 162 is also fixedly attached to the shaft 159 with its engaging pawl 163 attached to the housing 136 of the generator 160. The one-way clutch (not shown) used to mount the cord drum 155 over the shaft 159 and a ratchet 162 and a pawl 163 unit are directed such that as the cord 153 is pulled in the direction of the arrow 165, the cord drum 155 engages the shaft 159 and rotates it together with the gear 157 and the ratchet wheel 162. Then as the user releases the cord 153, the ratchet 162 and pawl 163 unit prevents the shaft 159 from rotating back in the opposite direction, but the one-way clutch which is used to mount the cord drum 155 over the shaft 159 (not shown) allows the cord drum to rotate back and have the cord 153 be wound back over it by the torque provided by the preloaded torsion spring 164.

The cord drum 155 can be provided with flanges 169 for cord 153 guidance as it winds over the cord drum 155. The opposite end of the cord 153 is fixed to the cord drum 155. Once the user has partially or fully pulled the cord 153, the user would then release or slowly let it rewind back over the cord drum 155 by the provided torsion spring 164 shown in the schematic of FIG. 5. The torsion spring 164 is fixed to the cord drum 155 on one end and to the housing 136 of the generator 160 on another end. The torsion spring 164 is also preloaded such that when the cord 153 is fully retracted and wound over the cord drum 155, there is still a minimal amount of residual torsional preloading left in the torsion spring 164 to keep the cord 153 securely inside the generator 160 housing. Once the cord 153 is wound completely over the cord drum 155, the ring 154 (or any other provided stop attached to the free end of the cord 153) comes against the passage 166, FIG. 1, of the generator 160 (100 in FIG. 1) and stops the free end of the cord 153 from entering the generator 160 housing.

Each time the user pulls the cord 153 in the direction of the arrow 165, the gear 157 and thereby the engaging gear 156 is rotated. In general, the gear ratio is selected to reduce the rate of rotation from the gear 157 to that of gear 156, thereby causing the transmitted torque to be amplified. The rotation gear 156 and thereby the drum 158 results in the winding of the power spring 137 as was previously described for the embodiment of FIG. 4. As can be seen in the schematic of FIG. 4, the winding of the power spring 137 tends to force the sleeve 139 to rotate, but the one-way clutch is oriented to transmit torque from the sleeve 139 to the shaft 141, and the stop element 144 prevents the shaft 141 from rotating since it is positioned against the rotational stop element 143. As a result, continuous pulling of the cord 153 in the direction of the arrow 165 and the resulting rotation of the cord drum 155 results in continuous winding of the power spring 137. As a result, mechanical potential energy is increasingly stored in the power spring 137. The user may pull the cord 153 several times to store more mechanical potential energy in power spring 137.

An advantage of the embodiment of FIG. 5 over that of FIG. 4 is that the user can pull the cord 153 several times and due to the gears 157 and 156 less forcefully and with shorter pulling distances to store a relatively large amount of mechanical potential energy in the power spring 137.

Then at any time, the user can pull the cord 167, which is attached to the stop element 144, possibly by the ring 168, which would slide the stop element 144 up and away from engagement with the rotational stop element 143 of the shaft 141, FIG. 4. Then as was described for the embodiment 130 of FIG. 4, the shaft 141 is now free to be rotated by the preloaded power spring 137. The preloaded power spring 137 will then begin to transfer its stored mechanical potential energy to the flywheel 147, shaft 141 and the rotor of the permanent magnet generator 148 as kinetic energy while a portion of the said mechanical kinetic energy is being transformed to electrical energy by the permanent magnet generator 148. Once the mechanical potential energy stored in the power spring 137 is transferred to the assembly of the shaft 141, flywheel 147 and the rotor of the permanent magnet generator 148, said assembly will continue to rotate and the one-way clutch 140 will prevent the assembly to back drive the power spring 137. The assembly of the shaft 141, flywheel 147 and the rotor of the permanent magnet generator 148 will then rotate until its stored kinetic energy is converted mostly to electrical energy and some to heat due to friction between the moving parts and losses in the permanent magnet generator 148.

It will be appreciated by those skilled in the art that the aforementioned losses in the electrical generators 100, 130 and FIGS. 1, 2, 4 and 5, due to friction between the moving parts and due to losses in the indicated permanent magnet generators are converted essentially all to heat. This generated heat can also be used to heat the body (in the case of the footwear of FIG. 1 the foot) by insulating the outer exposed surfaces of the generator (100 in FIG. 1) housing and providing relatively heat conducting material on its footwear side so that the generated heat is mostly transferred to the interior of the footwear (102 in FIG. 1).

In the schematic of FIG. 1, the electrical energy generator 100 (130 or 160 in FIGS. 4 and 5, respectively) is shown to be attached to the user boot 102. It is, however appreciated that the said generators may be attached to other pieces of worn clothing or equipment or devices such as radio receivers and transmitters, emergency electrical or electronic devices, flashlights, or the like. The electrical energy generator 100 (130 or 160 in FIGS. 4 and 5, respectively) may also be packaged as standalone devices that are used to power various electrical or electronic devices directly or be connected to the heating elements of the user worn elements or be used to charge rechargeable batteries of capacitors in such devices or charge rechargeable batteries or capacitors integrated into the said packaged electrical energy generators for later use.

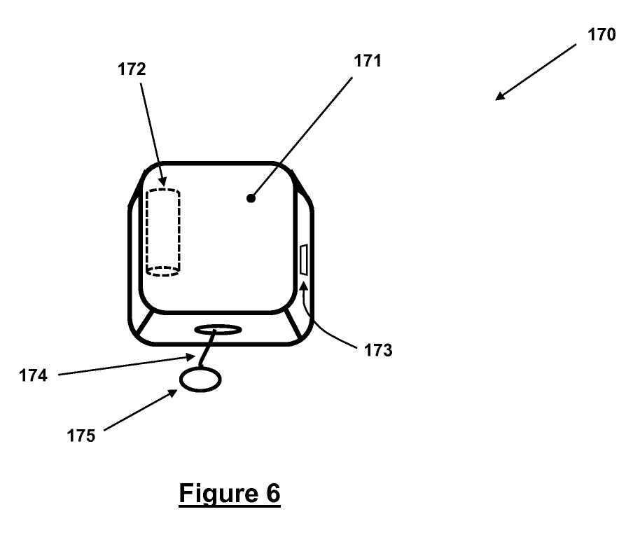

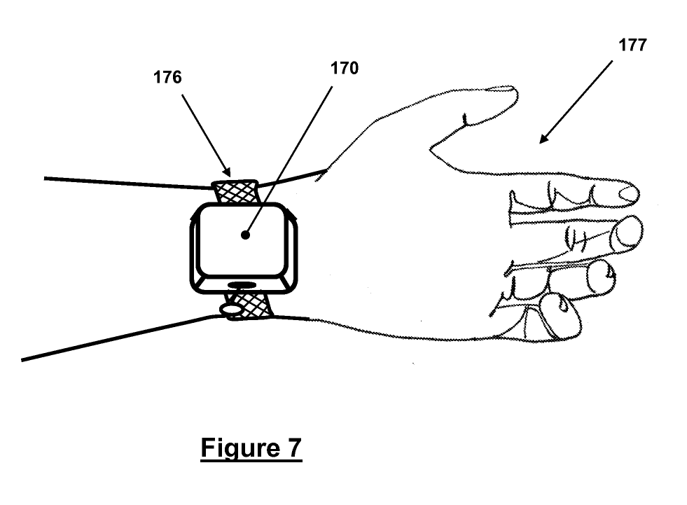

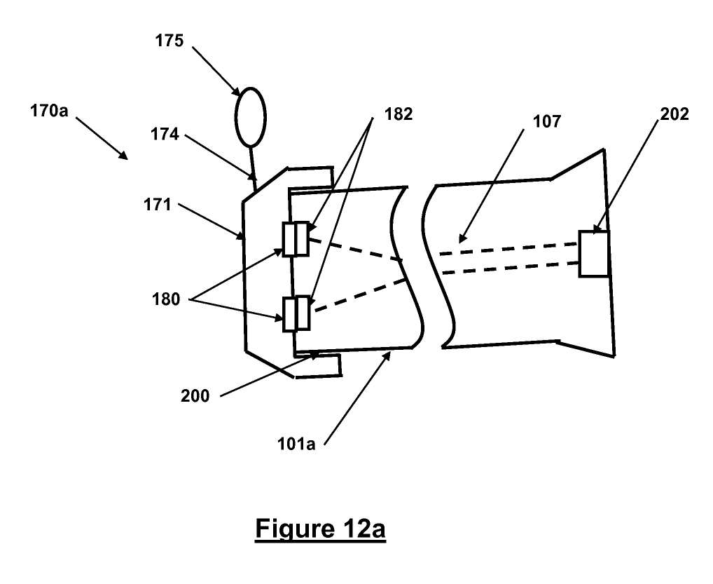

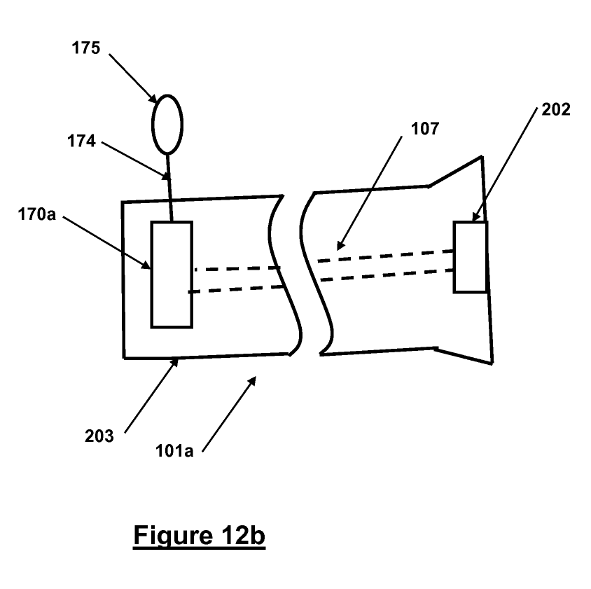

The schematic of a possible standalone electrical energy generator 170 is shown in FIG. 6. The design of the mechanism of the electrical energy generator 170 may be similar to that of either one of the embodiments 100, 130 or 160 of FIG. 2, 4 or 5, respectively, which is packaged in a housing 171. The electrical energy generator 170 can be provided with at least one electrical energy storage device 172, such as a capacitor or rechargeable battery or their combination appropriate for the applications at hand, and may be provided with an output connector 173 of appropriate type for the user to connect electrical or electronic devices to the electrical energy generator 170 (or an output cable with the desired connector—not shown). The user would then pull the generator cord 174, possibly via the end ring or possibly a commonly used T-shaped end element 175, to generate electrical energy. The electrical energy can then be used directly, for example to powering heating elements provided in certain wearable clothing or the like such as gloves or jackets, etc., or charge the storage device(s) 172 for later use or both. A simple switch (which can be operated manually by the user or resulting from an automatic detection, such as upon connection to a portable electronic device) can be used to toggle between charging the storage device 172 or outputting any electrical energy to the output connector 173. Output connector 173 can also be a male connector which directly connects to an electrical device for charging an internal battery of the electrical device, such as a smart phone (see description of FIGS. 12a and 12b below).

It will be appreciated by those skilled in the art that a standalone electrical energy generator of the 170 which is constructed with generator mechanism of either one of the embodiment 100, 130 or 160 of FIG. 2, 4 or 5, respectively, may be used as shown in the schematic of FIG. 6 or be provided with appropriate means of attaching to other objects or worn on clothing or the like. As an example, the electrical energy generator 170 may be provided with wrist band 176 (which for purposes of this disclosure is considered to be an article of clothing or apparel) to allow the generator 170 to be worn on the wrist of the hand 177. The user can then pull the generator cord of the electrical energy generator 170 by the other hand, as was previously described to power the intended devices or store electrical energy for later use.

Referring now to FIG. 8, the generator 170 may also be configured to releasably attach to an apparel, such as a side wall 101 of a boot 102. In such configuration, the generator 180 may include electrical contacts 180 on a surface of the housing (and electrically connected to an output of the electrical energy generated therein) which mate with corresponding contacts 182 on the apparel, such as the side wall 101 of the boot 102. The connection between contacts 180 and mating contacts 182 can be by any means known in the art, such as a magnetic attraction between the contacts 180 and contacts 182. Thus, a single generator 170 can be used with multiple pieces of apparel, such as one generator for both pf a pair of boots. Also, the apparel can be easily worn without the need for the generator at times when heating is not necessary. Also, the generator 170 can be configured to output electrical energy only to the contacts 180, or as described above with regard to FIG. 6, a selector (either manual or automatically detected) may be employed to switch electrical energy between two or more outputs (e.g., battery 172, output connector 173 or contacts 180). Although described in terms of an article of clothing, such as a sidewall 101 of a boot 102, the generator 170 illustrated in FIG. 8 can also electrically connect to a wall/casing/housing an electrical device, such as a smartphone, fire starter or flashlight by way of contacts 182 on the wall/casing/housing of such device to provide electrical energy for powering such device and/or charging an internal battery in such device. That is, the side wall 101 schematically illustrated in FIG. 8 can be configured as a wall/casing/housing of such electrical device.

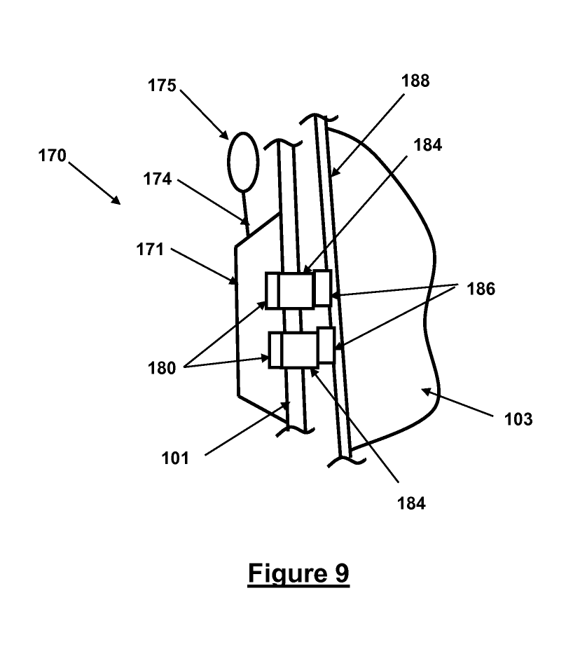

Referring now to FIG. 9, the generator 170 in FIG. 8 may also be used to pass electrical energy through from one article of clothing (e.g., the boot 102) to another article of clothing (e.g., a sock 188). As shown in FIG. 9, the sidewall 101 of the boot can have pass-through connectors 184, which on one side electrically connect with the contacts 180 of the generator 170 and one another side electrically connect with contacts 186 on the other article of clothing, such as socks 188. In this case, the socks 188 would have the heater pad(s) 106 that can be directly connected to the contacts 186 or through wiring (similar to wiring 107) threaded into the sock fabric. As discussed above, such contacts 180, 184, 166 can be by any means known in the art, such as a magnetic attraction between the contacts 180 and one side of contacts 184 and between contacts 186 and the other side of contacts 184).

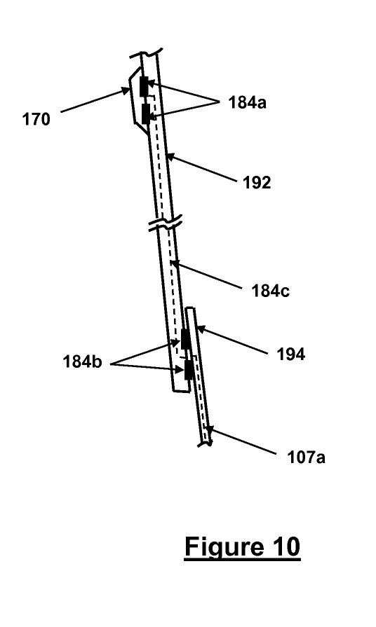

Also, referring to FIG. 10, the contacts 184 may be configured as two sets of contacts 184a and 184b and separated by wiring 184c. For example, a first set of contacts 184a on a first article of clothing, such as a coat 192, may be provided on the waist area of the coat 192 and electrically connected by wiring 184c through the coat body and sleeve to another set of contacts 184b on the sleeve. The other set of contacts 184b on the sleeve would then mate with contacts, such as contacts 186, on gloves 194, which to connect to heater pads, such as in the finger regions thereof or through wiring 107a to the heater pads. Other possibilities include mating contacts on the middle neck area of a coat and corresponding contacts on the back lower rim of a knit hat (where the heater pads can be positioned around an area corresponding to the ears of the user) and mating contacts on bottom of a pant leg (or ski pants) and corresponding contacts on the side wall of a shoe, boot (or ski boots) (where the heater pads can be positioned around an area corresponding to the toes of the user). In the latter example, the corresponding contacts on the side wall of a shoe, boot (or ski boots) can also be the pass through type (with or without wiring connecting the same) which in turn connect to mating contacts on socks (as discussed with regard to FIG. 9).

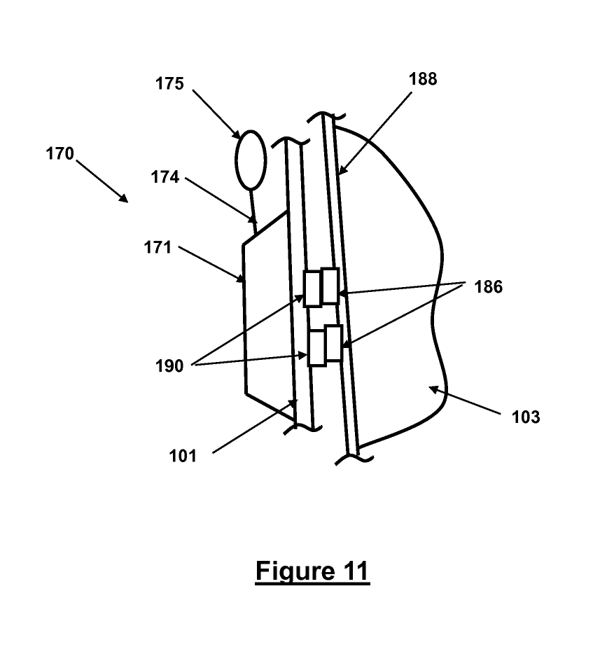

Also, the generator does not have to be releasably mounted to the first apparel (such as sidewall 101 of boot 102) in order to generate electrical energy for use in a second apparel (such as socks 188). That is, as shown in FIG. 11, the generator 170 can output its electrical energy directly to contacts 190 on the first apparel (e.g., sidewall 101 of boot 102) which can mate with the previously described contacts 186 on a second apparel (e.g., socks 188).

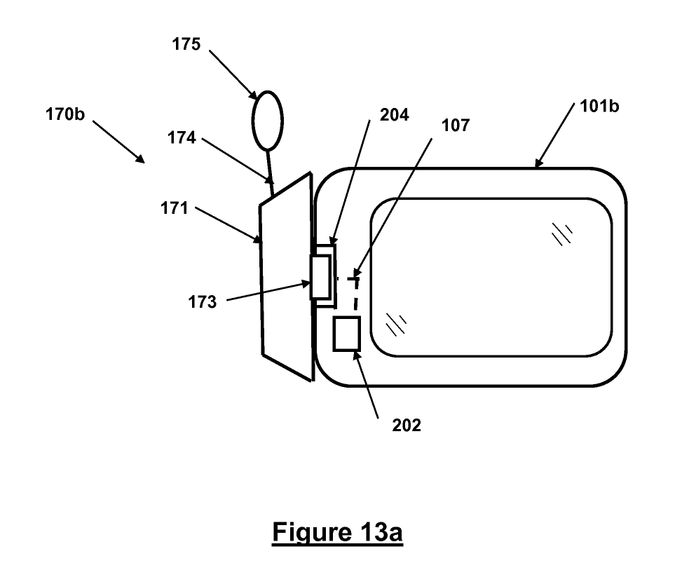

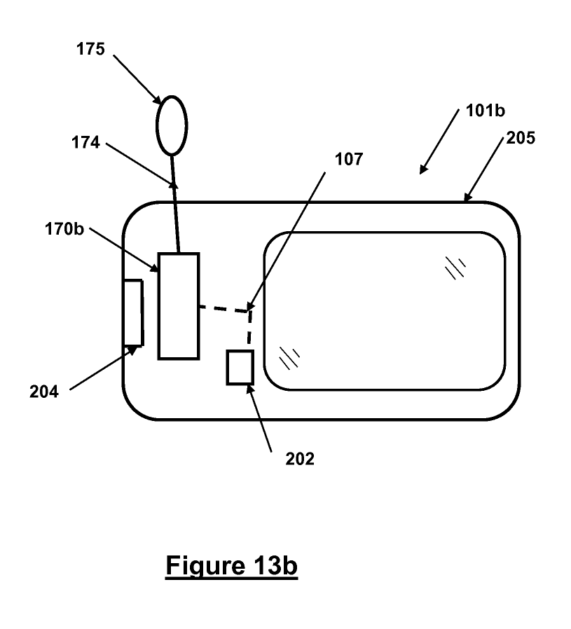

Referring now to FIGS. 12a, 12b, 13a and 13b, there is illustrated a generator 170a and 170b, respectively, for use with electrical electronic devices (which, as described above, may also be configured for use with articles of clothing). For purposes of this disclosure, reference to either “electrical” or electronic” devices refer to either or both of such devices. FIG. 12a illustrates a generator 170a, having any of the generator features described in the various embodiments above. The generator 170a is shown connected to another device, which can be a flashlight 101a. Such embodiment is not limited to flashlights and can include other devices, such as a radio, fire starter, portable pump, water filtration device, emergency siren, emergency transmitter which can transmit an emergency signal and/or location signal and the like. The flashlight 101a has a connector, such as contacts 182 which mate with the connector on the generator 170a, such as contacts 180. Although shown connecting with an end 200 of the flashlight, the generator 170a can connect to any surface of the flashlight or connect through a cord connecting the connector on the flashlight with the connector on the generator. Also, the generator 170a and/or flashlight 101a can be configured to prevent rotation of the generator 170a when the pull cord 174 is being pulled, such as having a non-circular shape or non-rotation pins disposed on one of the generator 170a or flashlight 101a and a mating channel on the other of the generator 170a or flashlight 101a. Internal wiring 107 can be used in the flashlight 101a to transfer the electrical energy output from the generator from contacts 182 to another component 202, which can be an energy storage device, such as a battery which powers a light source, and/or directly to the light source, such as an LED. As discussed above, the contacts 180, 182 can be magnetic so as to releasably fix the generator 170a to the flashlight 101a. Other attachments known in the art are also possible, such as a screw on attachment, interference type engagement or bayonet type attachment. Although the generator 170a is shown as being releasably attached to the device 101a, such as the flashlight, those skilled in the art will appreciate that the device 101a can be configured to include an integral generator 170a formed within its housing 203, as shown in FIG. 12b or permanently fixed thereto (such as with screws of other type fasteners).

Turning now to FIG. 13a, the same illustrates a generator 170b, having any of the generator features described in the various embodiments above. The generator 170b is shown connected to another device, which can be a smart phone 101b. Such embodiment is not limited to smart phones and can include other devices, such as a laptops, tablets and the like. The smart phone 101b has a connector, such as 204 which mates with a connector 173 on the generator 170b (configured in FIG. 12b as a male connector). Although shown connecting with an end 206 of the smartphone 101b, the generator 170b can connect to any surface of the smartphone or connect through a cord connecting the connector 204 on the smartphone with the connector 173 on the generator 170b. Internal wiring 107 can be used in the smartphone 101b to transfer the electrical energy output from the generator from connector 204 to another component 202, which can be an energy storage device, such as a battery which powers the smartphone 101b. Although discussed with regard to male/female connectors, the electrical connection between the generator 170b and the smartphone 101b can be of any type, such as magnetic the contacts similar to those discussed above. Although the generator 170b is shown as being releasably attached to the device 101b, such as the smartphone, those skilled in the art will appreciate that the device 101b can be configured to include an integral generator 170b formed within its housing 205 as shown in or permanently fixed thereto (such as with screws of other type fasteners). If formed integrally with the device 101b, the device 101b may include circuitry for charging an internal component 202, such as a battery, from either the generator 170b or from an AC/DC source. Such circuitry is well known in the art.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. A portable electrical generator comprising:
a housing;
a generator disposed within the housing and operable by a user from outside the housing to generate electrical energy;
an output for outputting the electrical energy from the generator to another device; and
a connector to connect the housing to one or more of an other device or an article of clothing.

2. The portable electrical generator of claim 1, wherein the generator includes a pull cord having a portion within the housing and a portion movable outside the housing and connected to the generator such that pulling the pull cord to move the movable portion away from the housing produces the electrical energy.

3. The portable electrical generator of claim 1, wherein the output and the connector comprise one or more contacts disposed on an external surface of the housing.

4. The portable electrical generator of claim 3, wherein the one or more contacts are magnetic contacts for releasably connecting the housing to mating magnetic contacts on the one or more of the other device or the article of clothing.

5. The portable electrical generator of claim 2, wherein the pull cord further comprises a pull means at the portion movable outside the housing for facilitating grasping of the pull cord by a user.

6. The portable electrical generator of claim 1, wherein the output is an electric connector.

7. The portable electrical generator of claim 1, wherein the output is an energy storage device.

8. The portable electrical generator of claim 1, wherein the connector is a mechanical connection to fix the housing to a surface of the one or more of the other device or the article of clothing.

9. The portable electrical generator of claim 1, wherein the connector is a cord connecting the output to an input of the one or more of the other device or the article of clothing.

10. The portable electrical generator of claim 2, further comprising a flywheel directly connected to a drum around which the pull cord is wound.

11. The portable electrical generator of claim 10, further comprising gearing provided between the drum and the flywheel for increasing a rotation speed of the flywheel as compared to the drum.

12. The portable electrical generator of claim 10, further comprising a power spring connected driving one of the flywheel or generator.

13. The portable electrical generator of claim 12, further comprising gearing provided between the drum and the power spring for increasing a rotation speed of the power spring as compared to the drum.

14. The portable electrical generator of claim 10, further comprising a clutch for allowing the pull cord to be pulled multiple times to increase the electrical energy output each time the pull cord is pulled.

15. A device comprising:
a body;
an internal energy consuming component; and
a generator attached to the body such that an output of the generator provides electrical energy from the generator to the internal energy consuming component.

16. The device of claim 15, wherein the body is an article of clothing.

17. The device of claim 16, wherein the article of clothing is footwear.

18. The device of claim 15, wherein the body is an electrical/electronic device.

19. The device of claim 15, wherein the internal energy consuming component is a heater.

20. The device of claim 15, further comprising an electrical connector disposed on a surface of the body and electrically connected to the internal energy consuming component, the electrical connector transferring the electrical energy output from the generator to the internal energy consuming component.

21. The device of claim 15, further comprising a first set of contacts connected to the output of the generator and a second set of contacts electrically connected to the internal energy consuming component, wherein the first and second sets of contacts are electrically connected to each other.

22. The device of claim 20, wherein the first and second sets of contacts are magnetic contacts for releasably connecting the generator to the body.

23. The device of claim 21, wherein the body includes first and second bodies, wherein the second body includes the internal energy consuming component and the second body further comprises a third set of contacts for electrically connecting the first and second sets of contacts.

24. The device of claim 23, wherein the first, second and third sets of contacts are magnetic contacts for releasably and electrically connecting the generator to the first body and the first body to the second body.

25. The device of claim 23, wherein the third sets of contacts comprises wiring electrically connecting the first and second sets of contacts.

26. An electrical/electronic device comprising:
a housing;
an internal energy consuming component disposed within the housing; and
a generator disposed with the housing body such that an output of the generator provides electrical energy from the generator to the internal energy consuming component;
wherein the generator includes a pull cord having a portion within the housing and a portion movable outside the housing and connected to the generator such that pulling the pull cord to move the movable portion away from the housing produces the electrical energy.
